(19) United States
(12) Patent Application Publication
(10) Pub. No.: US 2015/0005122 A1
(43) Pub. Date: Jan. 1, 2015

(54) CONVEYOR DRIVE BELT CONNECTION

(71) Applicant: Intelligrated Headquarters, LLC, Mason, OH (US)

(72) Inventors: Kevin Lawrence Klueber, Indian Springs, OH (US); David Martin, JR., Cincinnati, OH (US)

(21) Appl. No.: 14/317,207

(22) Filed: Jun. 27, 2014

Related U.S. Application Data
(60) Provisional application No. 61/841,123, filed on Jun. 28, 2013.
(60) Provisional application No. 61/841,416, filed on Jun. 30, 2013.

(51) Int. Cl. F16G 1/14; B29D 29/06

(52) U.S. Cl. CPC F16G 1/14; B29D 29/06
USPC 474/205; 264/345

(57) ABSTRACT

An endless drive belt is formed by creating a connection between two ends of a thermoplastic belt segment by fusing the cut ends of the thermoplastic material together. The thermoplastic belt segment has a “T” shaped cross section comprising a flat belt portion and a guide rib portion. The guide rib portion has equally spaced “V shaped notches imbedded therein that enable the stiff thermoplastic belt to bend at the notches, and not at the teeth defined between the notches to create bending portions that alternate with stiff portions. The two ends of the thermoplastic belt segment are cut in zigzagging interlocking fingers that intermesh and cut through both the flat belt portion and the teeth and notches in the guide rib portion. The zigzagging interlocking fingers are cut with the fingertips of each end of the belt defining a line that passes through the teeth.

### PRIORITY

This application claims priority to U.S. Provisional Patent Application Ser. No. 61/841,123, filed Jun. 28, 2013, entitled “Guided Conveyor Belt Connection,” and U.S. Provisional Patent Application Ser. No. 61/841,416, filed Jun. 30, 2013, entitled “Guided Conveyor Belt Connection,” the entire contents of which are incorporated by reference herein.

### BACKGROUND

Conveyors are components of high volume distribution and fulfillment systems. Conveyors have a conveying surface configured to receive, accumulate, and/or convey articles thereon. The conveying surface can be assembled from a number of conveyor sections that are linked together and driven by a single motor and an endless drive belt. The endless drive belt can be manufactured by cutting a strip of belting material to length from a roll, and connecting the ends together with a belt connection. To propel articles along the conveyor, the motor can drive the endless drive belt, which can be in contact with the conveying surface of the conveyor to drive the conveying surface. In some versions, the endless drive belt, motor, and a motor drive pulley interact to drive large loads of articles from a standing start. To accomplish this, the endless belt can be designed to bend around tight drive rollers and transmit torque from the motor to the belt and from the belt to the drive rollers without slippage. The endless drive belt can accelerate the load with minimal belt stretch and can track over long unsupported distances during operation without the belt falling off the track. This can result in higher loads and higher stresses on the belt connection. Accordingly, described herein is a belt connection for use with such endless drive belts.

### BRIEF DESCRIPTION OF THE FIGURES

The accompanying drawings, which are incorporated herein and constitute part of this specification, illustrate exemplary embodiments of the invention, and, together with the general description given above and the detailed description given below, serve to explain the features of the present invention.

FIG. 1 is an isometric view of a portion of a conveyor with conveying rollers and an endless drive belt.

FIG. 2 is an isometric view of the conveyor of FIG. 1, with the conveying rollers removed to show a plurality of actuator assemblies.

FIG. 3 is a fragmentary isometric view of an individual section of an actuator assembly of FIG. 2.

FIG. 4 is a fragmentary end view of the conveyor shown in FIG. 1 with an actuator assembly in a lowered position such that the endless drive belt is disengaged from the conveying rollers.

FIG. 5 is a fragmentary end view of the conveyor shown in FIG. 4 with the actuator assembly in a raised position to move the endless drive belt into driving contact with the conveying rollers.

FIG. 6 is a top plan view of a conveyor having a skewed roller section.

FIG. 7 is an enlarged top plan view of a section of the conveyor of FIG. 6.

FIG. 8 is an end cross-section view of the endless drive belt of FIG. 1.

FIG. 9 is a partial side view of the endless drive belt of FIG. 1 in a bent configuration.

FIG. 10 is a partial side view of the conveyor of FIG. 1 with a belt tensioning device.

FIG. 11 is a partial fragmentary isometric view of the endless guide belt of FIG. 1 wrapped around a pulley for guiding the endless drive belt.

FIG. 12 is a partial fragmentary isometric view of the endless guide belt of FIG. 1 wrapped around a tensioning pulley.

FIG. 13 is a partial fragmentary isometric view of the endless drive belt of FIG. 1, showing a first end and a second end of the endless drive belt with intermeshing fingers formed therein.

FIG. 14 is a partial isometric view of the first end and the second end of the endless drive belt of FIG. 13 being cut within a cutting fixture.

FIG. 15 is a partial isometric view of the endless drive belt of FIG. 13 placed over a connection tool prior to creating a connection in the endless drive belt.

FIG. 15a is a side view of the connection tool of FIG. 15 in a closed position the connection to form the connection in the endless drive belt of FIG. 13.

FIG. 16 is a partial fragmentary top view of the endless drive belt of FIG. 13, showing a belt connection joining the ends of the endless drive belt together with the fingertips on each end of the belt defining a line that passes through a center of a tooth.

FIG. 17 is a partial fragmentary top view of the belt connection of FIG. 16, showing areas of stiffness extending laterally from several teeth.

FIG. 18 is a partial fragmentary top view of the endless drive belt of FIG. 13, showing a belt splice cut therein joining the ends of the endless drive belt together with the fingertips on each end of the belt defining a line that passes along a notch.

FIG. 19 is a partial fragmentary top view of the belt connection of FIG. 18, showing areas of stiffness extending laterally from several teeth.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference.

The word “exemplary” is used herein to mean “serving as an example, instance, or illustration.” Any implementation described herein as “exemplary” is not necessarily to be construed as preferred or advantageous over other implementations.

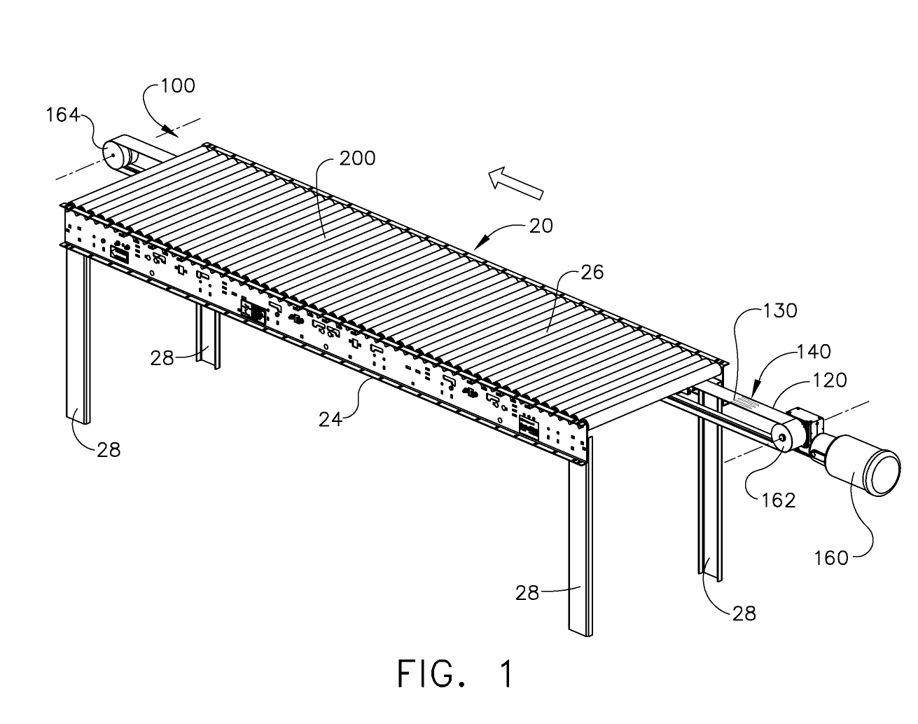

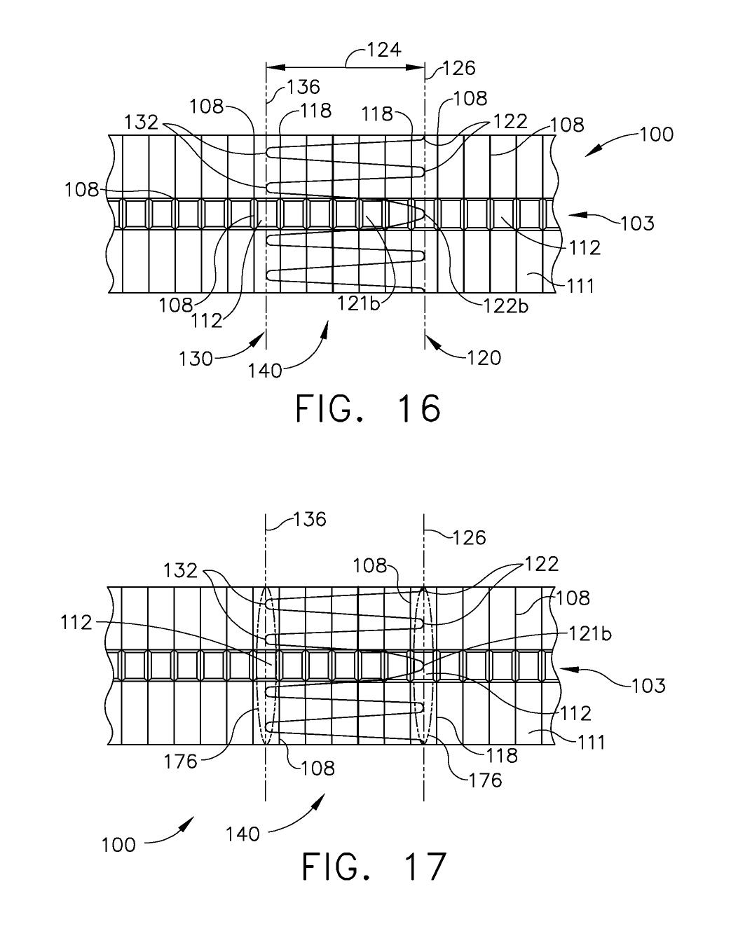

Referring now to the drawings in detail, FIG. 1 is a perspective view of a portion of an accumulation conveyor 20 which is well known in the art, and described in greater detail in in U.S. Pat. No. 6,889,822, which is incorporated herein by way of reference in its entirety. Accumulation conveyor 20 comprises selected zones of rollers 26 that can selectively engage with endless drive belt 100. Engagement of zone of rollers 26 with a moving endless drive belt 100 can rotate the zone of rollers 26 and move articles (not shown) located thereon. Endless drive belt 100 may be formed in an endless loop that passes around an idler pulley 164 and drive pulley 162, and may be driven by motor 160. As show in FIGS. 16-17, the endless drive belt 100 can be formed from a thermoplastic belt segment 110 that is cut to length, and joined together at ends thereof with a connection 140. Alternately, as described below, thermoplastic belt segment 110 can be cut differently and the ends joined together with splice 240.

The belting material of thermoplastic belt segment 110 can be formed in long lengths, stored in rolls (not shown) and cut to a length 105 (not shown) to make endless drive belt 100. An endless drive belt 100 of any size can be made by cutting the thermoplastic belt segment 110 to the appropriate length, and joining a first end 120 and a second end 130 of the thermoplastic belt segment 110 together with the connection 140 of the present innovation, or with splice 240. The results of life testing of connection 140 and splice 240 are described below.

While one accumulation conveyor 20 is shown being driven by endless drive belt 100, multiple accumulator or conveyor sections (not shown) can be added upstream and downstream of the accumulation conveyor 20, and the same endless drive belt 100 can drive them.

Accumulation conveyor 20 includes two spaced apart frame members or sides 24 that support a plurality of rollers 26 extending transversely between sides 24, which are elevated on legs 28. Rollers 26 define an upper conveying surface 200 on which articles being transported are located. For clarity, drive motor 160, drive pulley 162, and idler pulley 164 are shown floating in space, but are normally attached adjacent to an upstream end and a downstream end of the conveying surface 200 respectively.

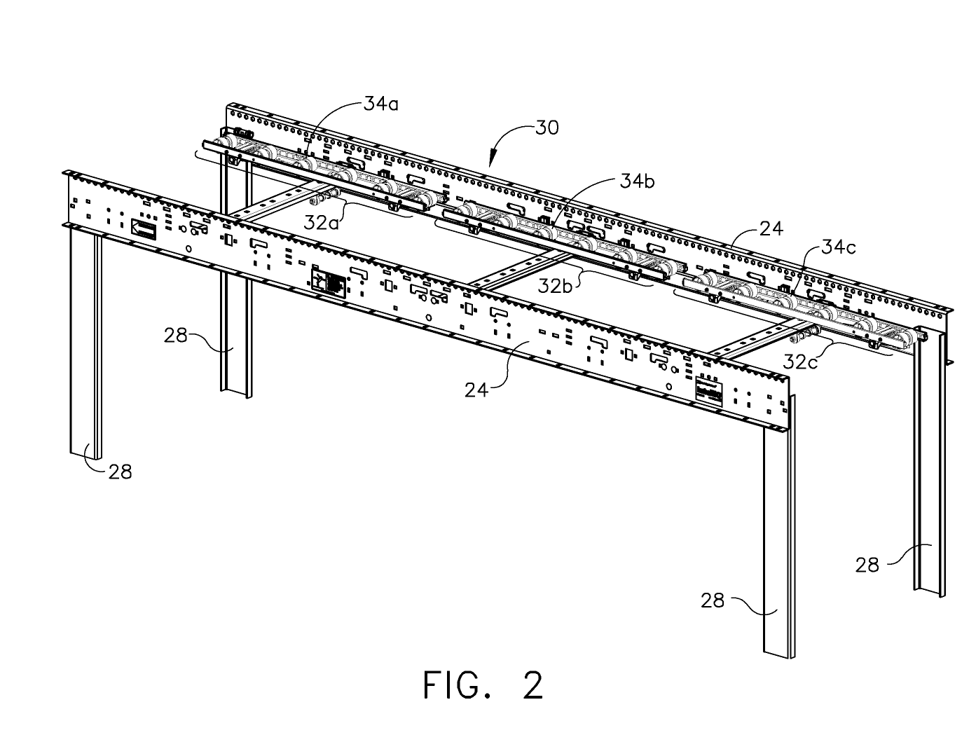

FIG. 2 shows a section 30 of accumulation conveyor 20 of FIG. 1 with rollers 26 and endless drive belt 100 removed for clarity. Section 30 comprises a plurality of zones 32 that are individually controllable. Each of the plurality of zones 32 are identified as zones 32a, 32b, and 32c. Each zone 32 is defined by a respective actuator assembly 34, identified as 34a, 34b, and 34c, each of which is controllable independent of the other actuator assemblies 34. Although the length of a zone 32 may vary, in the embodiment depicted, the zones can be about 36 inches long. Endless drive belt 100 can engage with any or all of zones 32a, 32b, and 32c.

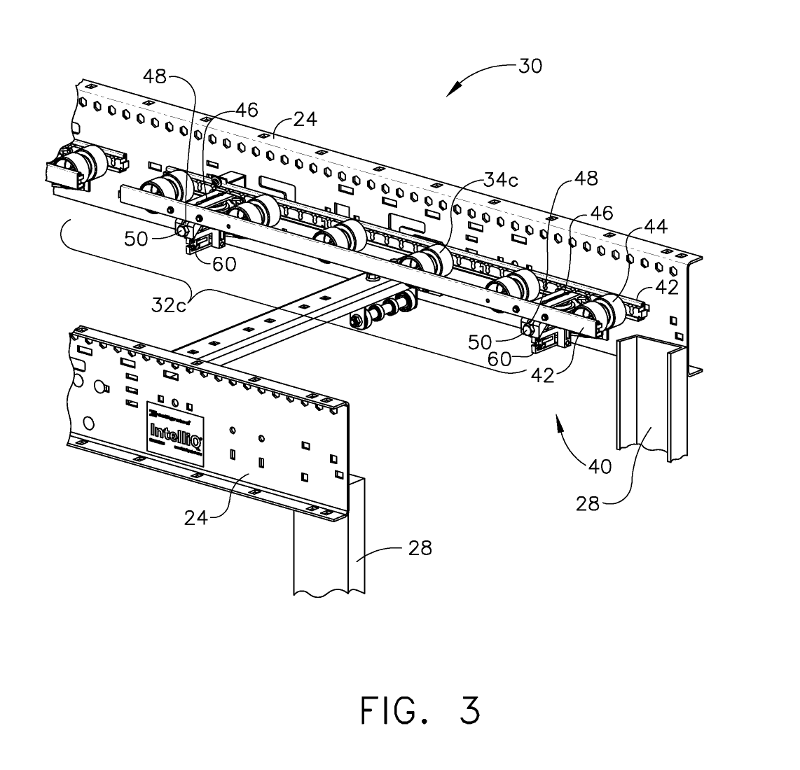

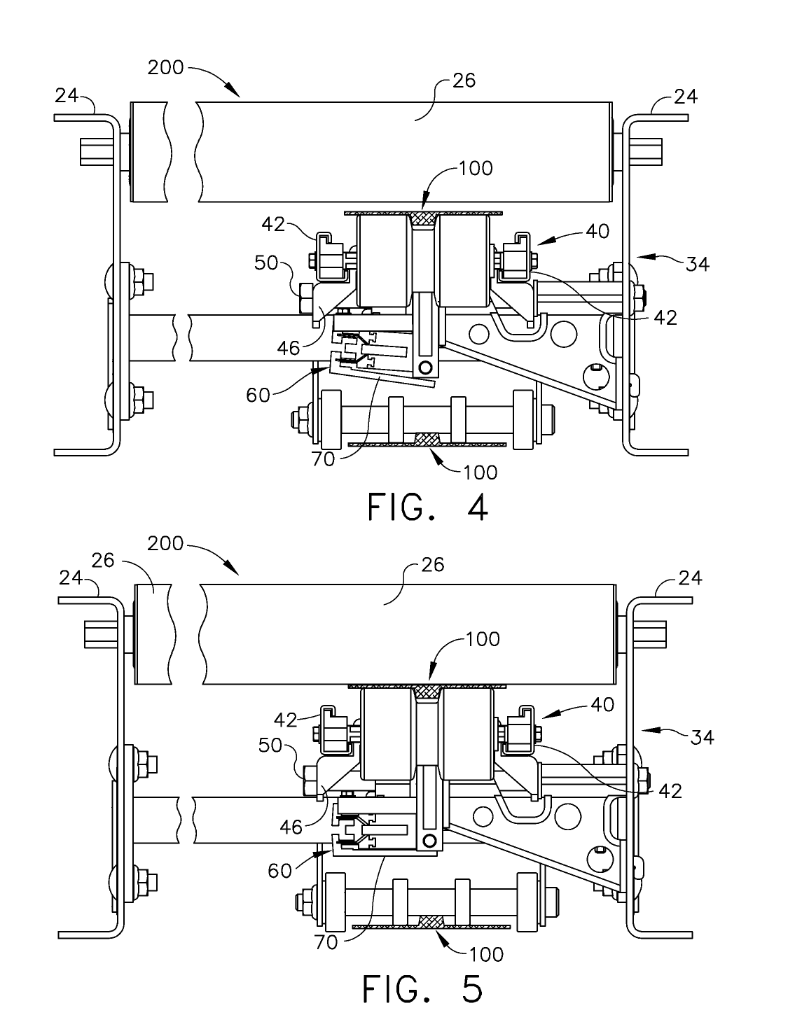

Referring to FIGS. 3 and 4, actuator assembly 34c is shown. As depicted, actuator assembly 34c can comprise one or more frame member 42 with one or more pressure rollers 44 supported therebetween. Frame member 42 can attach to shoe spreaders 46 which include vertical slots 48. Bolt 50 passes through vertical slots 48 to liftably attach actuator assembly 34c to side 24. Lift assemblies 60 attach to wall 24 and can comprise actuators 70 that when actuated, liftingly engage lift assemblies 60 with actuator assembly 34c. Actuators 70 can be fluidic actuators 70 actuated by compressible or incompressible fluids, but are not limited thereto.

Lift assemblies 60 may raise and lower actuator assembly 34c relative to sides 24 when activated (FIG. 3), and lower actuator assembly 34c when de-activated (FIG. 4). This raising and lowering action engages or disengages one of the individually controllable zones 32a, 32b. 32c, 32d with the endless drive belt 100.

Both FIGS. 4 and 5 show end views of the accumulation conveyor 20 with endless drive belt 100 sectioned. In FIG. 4, actuator 70 is un-actuated which lowers lift assemblies 60 and shoe assembly 40 away from rollers 26. The downward motion of shoe assembly 40 disengages the endless drive belt 100 from contact with rollers 26 as shown.

FIG. 5 shows lift assembly 60 with actuator 70 in the actuated position which forces shoe assembly 40 upwards to push endless drive belt 100 into driving contact with rollers 26. De-energizing actuator 70 drops shoe assembly 40 back to the positions shown in FIG. 4.

### Skewed Roller Accumulator

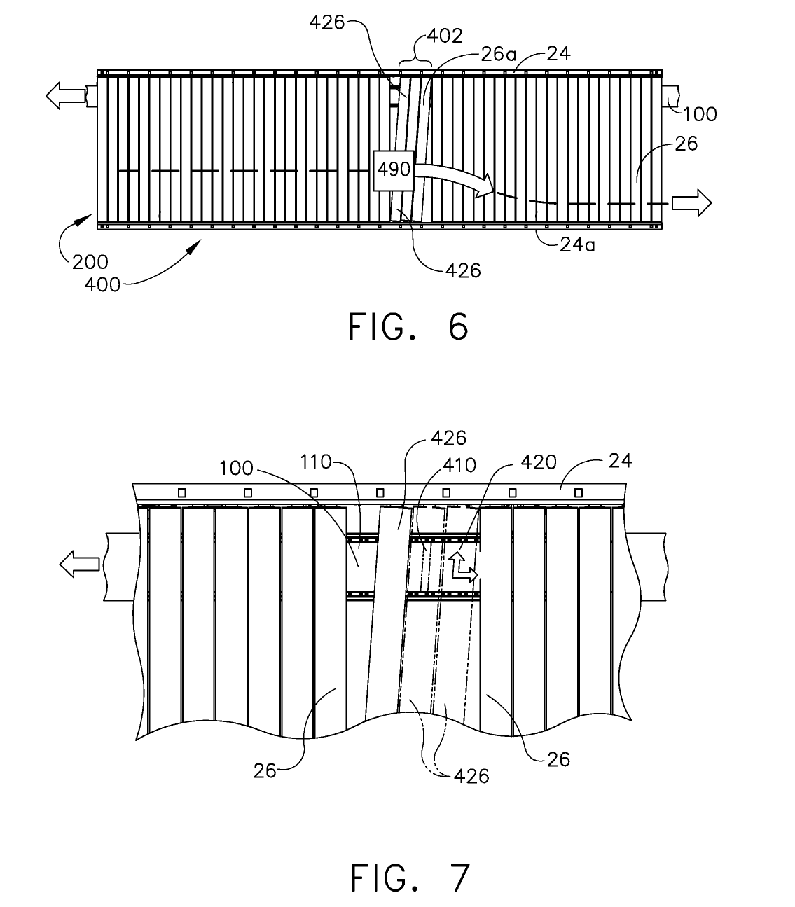

FIG. 6 shows a top view of a skewed roller conveyor 400 with a skewed roller section 402. Skewed roller conveyor 400 is generally similar to the previously described accumulation conveyor 20 with rollers 26 perpendicular to sides 24, but differs by having a skewed roller section 402 replacing a section of perpendicular rollers 26. Skewed roller section 402 has a section of skewed rollers 426 tilted at an angle relative to sides 24. Rollers 26 provide a forward motion to article 490, and skewed rollers 426 provide both a forward motion and a lateral or sideways motion of article 490 towards side 24a. Skewed roller section 402 depicted has three skewed rollers 426 that are parallel to each other and skewed at an angle other than 90 degrees relative to sides 24 to bias articles 490 fed therethrough into a line of moving articles aligned against side 24a (see dashed line). Skewed rollers 426 are shown moving article 490 forwards and towards side 24a.

FIG. 7 shows a top view of a portion of the skewed roller section 402 with two of the three skewed rollers 426 shown in phantom for clarity. Endless drive belt 100 is shown underneath traveling parallel with sides 24 in the direction shown. Each of the three skewed rollers 426 makes an angled contact footprint 410 with endless drive belt 100 and one contact footprint 410 is shown for one of the skewed rollers 426 in phantom. Each angled contact footprint 410 of the skewed rollers 426 places an angled force on the moving endless drive belt 100, and for clarity, the skew of contact footprint 410 is shown exaggerated. Force vectors 220 show the X and Y forces exerted on the belt by each of the skewed rollers 426. Note that one of the arrows in the force vector 220 is a drag force (see arrow adjacent contact patch) opposite to the direction of motion of the endless drive belt 100 (see arrow at end of endless drive belt 100) and the other arrow in the force vector 220 is a side force pushing endless drive belt 100 towards the side 24. Each of the skewed rollers 426 provides a drag force and a side push that pushes the endless drive belt 100 towards side 24.

Note that one of the arrows in the force vector 220 is a side force exerted on the endless drive belt 100, and each of the skewed rollers 426 pushes the endless drive belt 100 towards side 24.

### Thermoplastic Belt

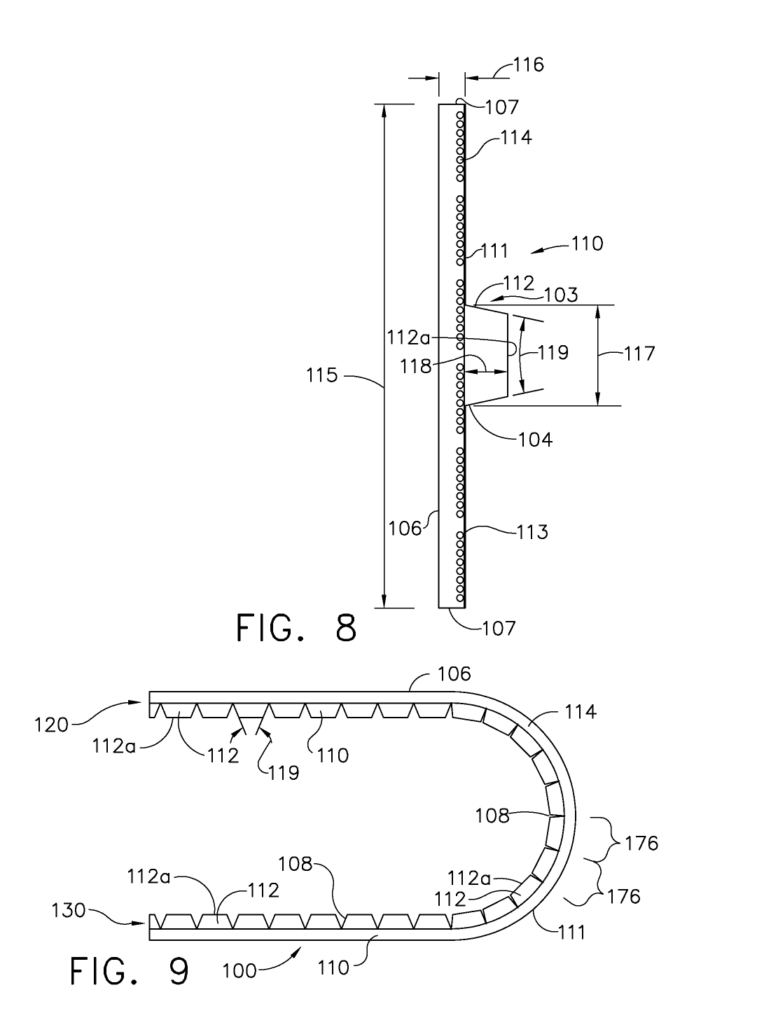

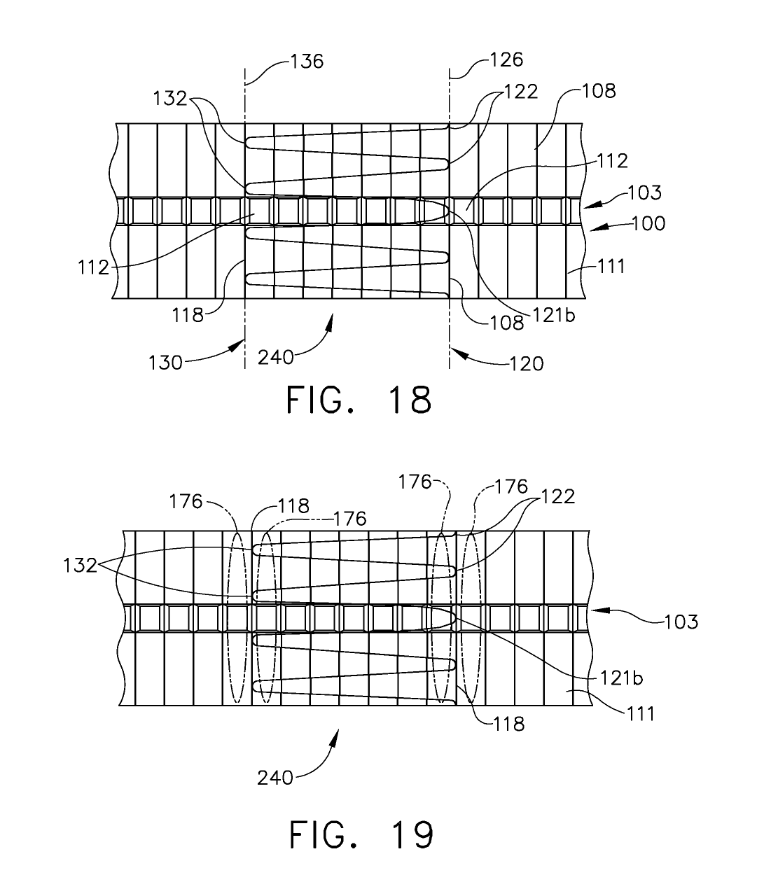

FIG. 8 is an end cross section of thermoplastic belt segment 110 which is used to make endless drive belt 100. Thermoplastic belt segment 110 can be a thermoplastic or polymeric material such as but not limited to a urethane, and can be an elastomer. An endless drive belt 100 made of thermoplastic urethane may be strong in tension, can be easily manufactured in long lengths, can be shaped or designed to resist side loads from skewed rollers, and the ends can be welded or fused together with heat. As described previously, the polymeric thermoplastic belt segment 110 can be joined together with connection 140 (see FIG. 16-17) or with splice 240 (see FIGS. 18-19) to create endless drive belt 100. The difference between connection 140 and splice 240 will be described in more detail below. Endless drive belt 100 has been developed through more than two years of engineering design and testing in a conveyor such as but not limited to the accumulation conveyor 20 or skewed roller conveyor 400.

Thermoplastic belt segment 110 can be generally “T” shaped in cross section (FIG. 8) and can comprise a flat belt portion 111 having a guide rib portion 103 projecting or extending centrally from a tooth side 113 along length 105 of endless drive belt 100 from first end 120 to second end 130. Flat belt portion 111 can provide power transmission, and guide rib portion 103 can guide the endless drive belt 100 at the pulleys to control belt “walking” during operation. Flat belt portion 111 and guide rib portion 103 can be formed separately and joined, or can be formed together in a single operation. Flat belt portion 111 can have a flat width 115 and a flat height 116. A roller contact surface 106 is on the opposite side of the flat belt portion 111 to drive rollers 26 and skewed rollers 426. Edges 107 can extend between tooth side 113 and the roller contact surface 106. The guide rib portion 103 can have a tooth height 118 and a tooth width 117.

Flat belt portion 111 can have a belt width 115 that is between about 1-8 inches, such as about 3 inches in width. Flat belt portion 111 can have a flat belt height 116 between about 0.050-0.50 inches, such as about 0.16 inches in height. Teeth 112 can have a base width 117 between about 0.050-0.90 inches, such as about 0.48 inches in width. Teeth 112 can have a tooth height 118 between about 0.050-1.00 inches, such as about 0.26 inches high. Teeth 112 can be beveled to an overall angle 119 of between about 5-120 degrees.

A plurality of bendable tensile members 114 can extend lengthwise within flat belt portion 111 for added tensile strength and stretch resistance, can be placed in parallel to each other, and can be placed adjacent to tooth side 113. Bendable tensile members 114 can be formed from an aramid fiber, such as Kevlar®, but are not limited thereto. Additional materials for the bendable tensile members 114 can include, but are not limited to: steel, polyester, Nylon®, Nomex®, Vectran®, or any other suitable cord materials for belting. Bendable tensile members 114 can be separate fibers or fibers twisted together, and can be placed within thermoplastic belt segment 110 during the belt forming process.

A coating 104 can be applied to guide rib portion 103 to provide increase wear resistance and can comprise, but is not limited to, a layer of woven nylon fabric. Coating 104 can be between about 0.001-0.20 inches thick, such as about 0.005 inches thick.

Thermoplastic belt segment 110 can be formed from thermoplastic urethane with a durometer of between about 76 and about 95 on the Shore A scale. For instance, thermoplastic belt segment 110 can have a durometer of about 85 on the Shore A Scale, but is not limited thereto. Durometer is a measure of “hardness” of an elastomeric material, and can be measured by a Shore A test instrument that applies an impact force to the urethane material, and measures the hardness of the urethane as an indentation depth resulting from that force. The 85 Shore A urethane material used in the thermoplastic belt segment 110 can be stiff, and can fall between a “hard” value of 70 Shore A described as a shoe heel, and an “extra hard” value of 90 Shore A described as a golf ball. This range information can be found at “http://www.casterland.com/info-durometer.htm”.

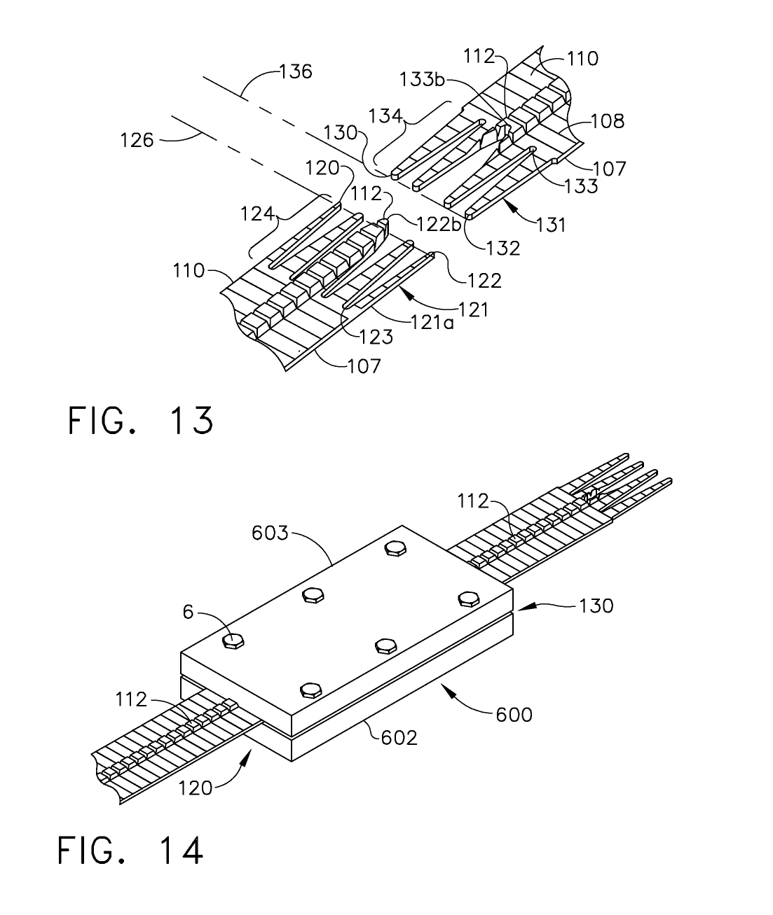

Thermoplastic belt segment 110 made from 85 Shore A durometer thermoplastic urethane is both stiff and resistive to bending. As shown in FIG. 9, a plurality of notches 108 may be indented into guide rib portion 103 from the first end 120 to the second end 130. Notches 108 can enable the thermoplastic belt segment 110 to bend. Notches 108 can be “V” shaped, may be equally spaced, and can divide the guide rib portion 103 of thermoplastic belt segment 110 into teeth 112. A vertex of the “V” of notches 108 can be oriented perpendicular to the length 105 of thermoplastic belt segment 110. Alternately, thermoplastic belt segment 110 can be viewed as a toothed belt with a center line of teeth 112 extending from the flat belt portion 111 and with notches 108 between each of the teeth 112. As shown in FIGS. 8-19, notches 108 can extend into the flat belt portion 111. In FIGS. 13-19, he extension of notch 108 into flat belt portion 111 can be seen as the series of parallel lines on the tooth side 113 with one line passing through each notch 108. Turning back to FIG. 8, thermoplastic belt segment 110 is at its thinnest at the “V” shaped notches 108 and the cross section of the thermoplastic belt segment 110 is less than the cross section of the flat belt portion 111. Each notch 108 creates a localized soft portion or bending portion in the thermoplastic belt segment 110 that can confine bending to notches 108. Bending may be easiest at the vertex of the “V” shaped notches 108, each of which extend into flat belt portion 111. At the vertex of the “V” shaped notches 108, the bendable cross section of the thermoplastic belt segment 110 is less than the cross section of the flat belt portion 111.

At each of the teeth 112, the bendable cross section of the thermoplastic belt segment 110 is “T” shaped and comprises both the guide rib portion 103 and the flat belt portion 111. The “T” shape across the teeth 112 is stiff and resistive to bending, and can create stiff portions in the thermoplastic belt segment 110. This creates alternating stiff portions (teeth 112) and bending portions (notches 108) along the length 105 of the thermoplastic belt segment 110 from the first end 120 to the second end 130. Coating 104 can conform to the teeth 112.

In in FIG. 9, thermoplastic belt segment 110 is shown bent about 180 degrees into a loop. Thermoplastic belt segment 110 bends through the guide rib portion 103 at the points of least resistance, that is, at the narrow point of the “V” notches 108 where the thermoplastic belt segment 110 is the thin. The stiff teeth 112 are non-bending as indicated by flat tops 112a of the teeth 112 in the 180 degree bend. As best shown in FIG. 9, the thermoplastic belt segment 110 bends at the notches 108 between the teeth 112, and along the flat belt portion 111 laterally away from the effects of the stiff teeth 112. Between the notches 108, each tooth 112 can create a localized area of stiffness 176 that is resistant to bending and exhibits little or no bending therein (see FIGS. 17 and 19). In FIGS. 17 and 19, several representative areas of stiffness 176 are shown, and they can be generally oval in shape and can extend laterally from each tooth 112 across a substantial portion of the flat width 115 of the thermoplastic belt segment 110. Between the areas of stiffness 176, soft or bending portions extend in an hourglass shape from the notches 108. In the thermoplastic belt segment 110, the notches 108 effectively creates soft or bending portions that alternate with stiff or non-bending portions caused by the teeth 112.

Bending thermoplastic belt segment 110 at the notches 108 creates bending stresses in the soft or bending portions about the notches 108 of the thermoplastic belt 110 and not in the stiff or non-bending portions in the areas of stiffness 176 adjacent to the teeth 112. This means that the thermoplastic belt 110 can comprise alternating areas of high stress (about notches 108) that alternate with areas of low stress (areas of stiffness 176).

The soft or bending portions at notches 108 can enable endless drive belt 100 to bend around smaller diameter pulleys, such as a pulley between about 2-4 inches in diameter, such as a pulley about 3 inches in diameter. The inclusive angle 109 on the teeth 112 can be used as a bend limiter when the teeth 112 come together to touch.

### Belt Tensioning Mechanism

FIG. 10 shows a schematic side view of a belt tensioning mechanism 300 that can maintain an operating tension on the endless drive belt 100 during operation. Belt tensioning mechanism 300 can be used with any belt driven conveyor such as accumulation conveyor 20 or skewed roller conveyor 400. Belt tensioning mechanism 300 can prevent over-tightening of the endless drive belt 100 to increase belt life, protect connection 140 and splice 240 from excess belt tension, and can reduce under-tightening of endless drive belt 100 that can result in belt slippage. Belt tensioning mechanism 300 may provide a tension of between about 25-150 lbf, such as between about 50-125 lbf, such as between about 61-110 lbf on endless drive belt 100. Belt tensioning mechanism 300 can comprise a tensioning apparatus 314 such as, but not limited to, a pneumatic cylinder connecting between the endless drive belt 100 and a side 24 of the accumulation conveyor 20 or skewed roller conveyor 400. Tensioning apparatus 314 can move longitudinally in the directions shown by the double headed arrow. A clevis 312 may attach to the tensioning apparatus 314 and a tensioning pulley 310 can rotate within clevis 312. When the tensioning apparatus 314 is actuated, the clevis 312 and the tensioning pulley 310 can move to maintain the endless drive belt 100 at a desired tension. A reverse bend pulley 320 can be rotatably attached to one of the sides 24, 24a, and can maintain a nearly 180 degree belt wrap around the tensioning pulley 310. In FIG. 10, the teeth 112 on the endless drive belt 100 generally face inward and for clarity, several teeth 112 are shown.

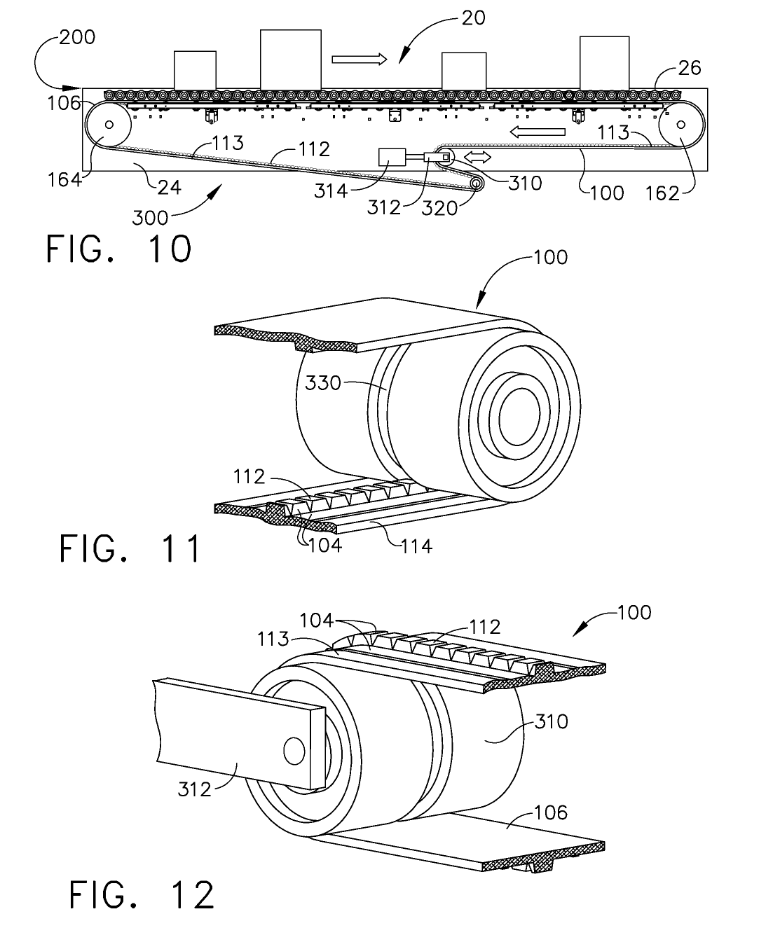

FIG. 11 is a representative depiction of a typical flangeless pulley such as drive pulley 162, idler pulley 164, and reverse bend pulley 320 and shown with endless drive belt 100 wrapped nearly 180 degrees therearound. The wrap configuration places the tooth side 113 into contact engagement with pulleys 162, 164, 310, and 320 and the bendable tensile members 114 in a low bending stress position directly adjacent to pulleys 62, 164, and 310. Each one of these pulleys 162, 164, 310 includes a guide slot 330 configured to receive the teeth 112 of the guide rib portion 103. The placement of the teeth 112 in the guide slot 330 prevents sideward movement of endless drive belt 100, and can prevent the endless drive belt 100 from walking off pulleys 162, 164, 310, and 320 during operation.

In FIG. 12, endless drive belt 100 is shown to be back-bent or wrapped backwards around tensioning pulley 310 held by clevis 312. When endless driver belt 100 is back-bent, the teeth 112 and the tooth side 113 extend outwards, and tensioning pulley 310 is in contact with the roller contact surface 106 of the endless drive belt 100.

During operation, the flat belt portion 111 can perform as the force transmission portion of the thermoplastic belt segment 110, and the teeth 112 of the guide rib portion 103 can engage with guide slots 330 in the pulleys of the accumulation conveyor 20 and the skewed roller conveyor 400. The engagement of the teeth 112 with the pulley guide slots 330 can control side movement of the endless drive belt 100 at the pulleys. Since the thermoplastic belt segment 110 may be configured to fit in existing products, such as but not limited to accumulation conveyor 20 and skewed roller conveyor 400, the thermoplastic belt segment 110 can be a balance between fixed width, stiff belt material (durometer), belt life, belt bending stresses, and flat height 116. These factors can also pay a part in controlling side deflections of the thermoplastic belt segment 110.

### Belt Fingers

As described previously, endless drive belt 100 is fabricated from a length of thermoplastic belt segment 110 that is cut to a length 105 having first end 120 and second end 130. First end 120 can be cut or formed to intermesh tightly together with the second end 130 by cutting first fingers 121 in the first end 120 and cutting second fingers 131 in the second end 130. As shown in FIG. 13, the first fingers 121 and the second fingers 131 can be cut in zigzag profiles that can intermesh together as shown in FIGS. 16-19. The zigzag profile can be sinusoidal or tapered, and can be cut to intermesh without gaps between first fingers 121 and second fingers 131.

First fingertips 122 are located at the ends of the first fingers 121 and second fingertips 132 are located at the ends of the second fingers 131. The first fingertips 122 define a first line 126 tangent thereto and the first end 120, and the second fingertips 132 define a second line 136 tangent thereto and the second end 130 of the thermoplastic belt segment 110. First valleys 123 are located between first fingers 121 and second valleys 133 are located between second fingers 131 with both first and second valleys 123, 133 shaped to receive first and second fingertips 122, 132 of the opposite end of the thermoplastic belt segment 110. The first and second fingers 121, 131 are of equal length and can be elongated as shown.

When the zigzag profiles are cut into the thermoplastic belt segment 110 to make first fingers 121 and second fingers 131 therein, a part of first and second fingers 121, 131 may be formed at the edges 107 of the first end 120 and second end 130. The zigzag cuts form first fingers 121 and second fingers 131 so that when intermeshed, the edges 107 align. The zigzag profiled cuts used to form the first and second fingers 121, 131, can cut through one or more of the teeth 112 and notches 108, and when intermeshed, the notches 108 and teeth 112 of the first and second fingers 121, 131 align together to form complete notches 108 and teeth 112. This is done so that when the intermeshed fingers first and second fingers 121, 131 are fused or melted together to form the endless drive belt 100 with a process described below, the endless drive belt 100 bends uniformly at notches 108 at any point between the first end 120 and the second end 130.

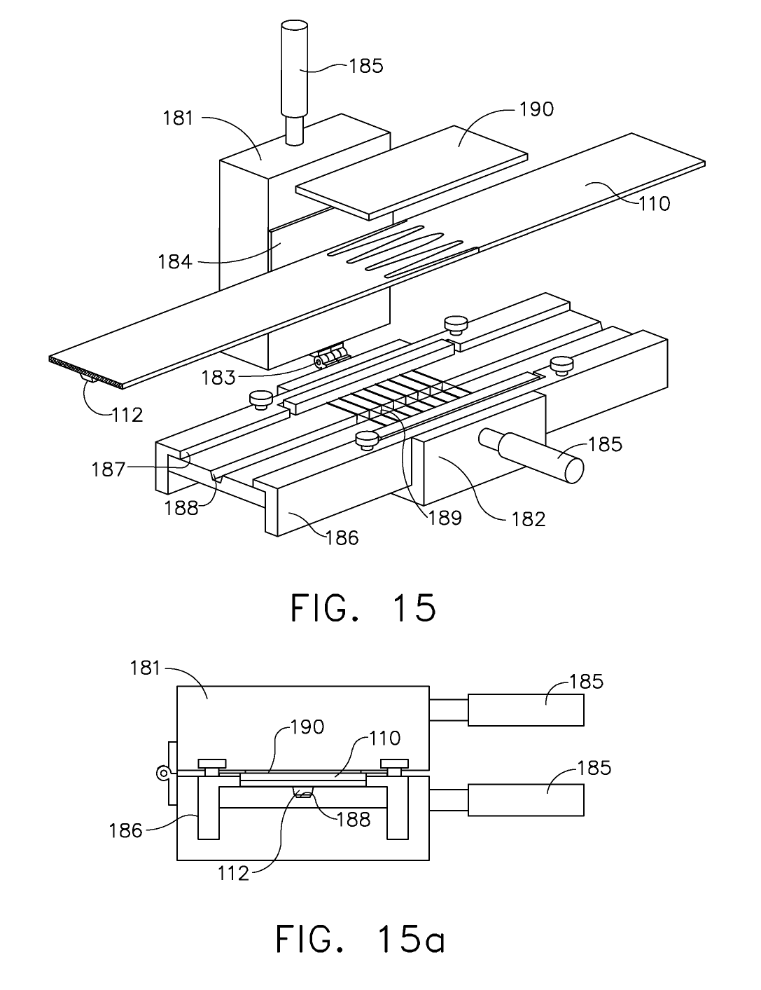

To form the zigzag profiles of the first fingers 121 and second fingers 131 in the thermoplastic belt segment 110, a cutting fixture 600 shown in FIG. 14 can be used. Cutting fixture 600 can use pressure and sharp knife edges to cut the ends of the thermoplastic belt segment 110, but the cutting process is not limited thereto. Cutting fixture 600 can comprise a lower cut plate 602 and an upper cut plate 603, and may cut one or more of the first end 120 and the second end 130 of the thermoplastic belt segment 110 at the same time. The lower cut plate 602 and the upper cut plate 603 can include cutting edges (not shown) to cut the zigzag profiles of first and second fingers 121, 131 in the thermoplastic belt segment 110. Belt alignment features such as one or more tooth shaped cavities 661 (not shown) can receive and align the ends of the thermoplastic belt segment 110 relative to the cutting edges prior to the cutting of the first and second fingers therein. During the cutting process, the first end 120 and the second end 130 of the belt are held in exact alignment with the cutting edges to ensure that the zigzag profile of the first and second fingers 121, 131 are cut correctly relative to the teeth 112 and notches 108. When the first and second ends 120, 130 are intermeshed after cutting, the notches 108 and teeth 112 on the first fingers 121 and the second fingers 131 should align perfectly. To perform the cutting, a closure device such as but not limited to a plurality of clamp bolts 607 can be used to bring lower cut plate 602 and upper cut plate 603 together to cut the first and second fingers 121, 131 into the thermoplastic belt segment 110. Cutting fixture 600 can cut both the urethane material and the bendable tensile members 114 within the thermoplastic belt segment 110, and can cut through one or more teeth 112.

When the zigzag cuts are made with the cutting fixture 600, the location of the cutting edges to the belt alignment features can have an effect on the life of the endless drive belt 100. Specifically, when the same zigzag cutting edge profile is used to create first fingers 121 and second fingers 131, the location of the zigzag cuts relative to the notches 108 and teeth 112 can affect the life of the endless drive belt 100. As described in the “BELT CONNECTION TESTING” section below, making the zigzag cuts with the first and second fingertips 122, 132 in line with notches 108 had a different effect than making similar profile zigzag cuts with the first and second fingertips 122, 132 defining first and second lines 126, 136 that pass through the teeth 112.

### Belt Connection

As shown in FIG. 15, connection tool 160 can be used to create endless drive belt 100 by fusing or melting together intermeshed first fingers 121 and second fingers 131 of belt segments 110. In addition to heat, adhesives, fillers, primers, radiant energy, friction, and/or other suitable materials or processes can be used to make the fusion between first end 120 and second end 130. In the present embodiment, connection tool 160 uses heat to fuse the urethane of the intermeshed first and second fingers 120, 130 together. Connection tool 160 can be used in a manufacturing factory, or used in the field to repair and/or replace damaged endless drive belts 100.

The thermoplastic urethane selected for thermoplastic belt segment 110 enables the first and second ends 120, 130 of the thermoplastic belt segment 110 to be melted, welded, or fused together to create the endless drive belt 100. For the belt connection 140, the thermoplastic belt segment 110 can comprise a first end 120 and a second end 120 with alternating stiff portions and bendable portions therebetween. The stiff portions of the belt are shown as oval areas of stiffness 176 (FIG. 17) caused by the teeth 112, and the bending portions of the belt 110 are at each of the notches 108. A first set of fingers 121 with first fingertips 122 terminate the first end 120 of the thermoplastic belt segment 111 and a second set of fingers 131 with second fingertips 132 terminate the second end of the thermoplastic belt segment 111. The second set of fingers 131 intermesh together with the first set of fingers 121 with the first and second fingertips 122, 132 located in a stiff portion of the belt (176).

As shown in FIG. 15, a connection tool 180 can be used to create the endless drive belt 100 by fusing or melting together the intermeshed first fingers 121 and the second fingers 131 of the thermoplastic belt segment 110. Connection tool 180 is shown in an open position, and can comprise a lid 181 and a base 182 connected together by a hinge 183. Handles 185 extend from lid 181 and base 182, and can be used to open and close lid 181, and to apply pressure onto the thermoplastic belt segment 110 during the formation of the connection 140. A heating element 184 may be embedded within at least one of lid 181 and base 182 to melt the thermoplastic urethane of the first and second fingers 121, 113 together. The heating element 184 may be turned off to allow the melted urethane to cool into a fused connection 140.

Base 182 can comprises an alignment frame 186 that is configured to receive the intermeshed first and second ends 120, 130 of the thermoplastic belt segment 110 within, and to hold the intermeshed first and second ends 120, 130 in alignment during the melting and cooling process. Alignment frame 186 contains a slot 187 to closely receive the flat belt portion 111 within, and groove 188 to closely receive the teeth 112. Cavities 189 can be centrally located within groove 188 and sized to closely receive the teeth 112 of first and second fingers 121, 131 within, as well as several teeth 112 outside of the first and second fingers 121, 131. A heating plate 190 may be provided to lay on top of the flat belt portion 111 to conduct heat from the lid 181 to the thermoplastic belt segment 110.

To form the connection 140, the thermoplastic belt segment 110 is placed within the alignment frame 17 of the connection tool 180 with the intermeshed first and second fingers 121, 131 received in the cavities 187. Slot 187 holds the intermeshed first end 120 and the second end 130 of the thermoplastic belt segment 110 together in alignment as shown in FIG. 16 with the with the first and second fingertips 121, 131 located in a stiff portion (teeth 112) of the belt. Cavities 189 ensure that the first and second fingers 121, 131 are held within the connection tool 180 with the second fingers 131 intermeshed together with the first set of fingers 121 and with the first and second fingertips 122, 132 located in a stiff portion (176) of the belt. Alignment frame 186 can include a silicone or aluminum core. Heating element 184 can be turned on to heat the clamped urethane material of the thermoplastic belt segment 110 to a temperature just over melting. For instance, heating the urethane to a temperature of about 171 degrees Centigrade for a time of about 300 seconds was found to melt the urethane first fingers 131 to second fingers 131 and to provide a long lasting and durable connection. Other temperatures and times will be apparent to one with ordinary skill in the art in view of the teachings herein. Heating element 184 can then be de-activated to allow thermoplastic belt segments 110 to fuse together while cooling to a safe temperature for removal. When first fingers 121 and second fingers 131 are fused together, the ends of the bendable tensile members 114 remain severed, and may not join together during the welding or fusion process (not shown).

Connection tool 160 can be used to make two different versions of endless drive belt 100 that differ in the location of the zigzag cuts of first fingers 121 and second fingers 131 relative to notches 108 and teeth 112. In FIGS. 16-19, first and second fingers 121, 131 are shown fused together, and the outlines of the zigzag cuts used to make first and second fingers 121, 131 are shown overlaid thereon to show where bendable tensile members 114 are severed, and where the material is fused together between first fingers 121 and second fingers 131. Belt connection 140 is shown in FIGS. 16-17 with the zigzag outline of first and second fingertips 122, 132 defining first and second lines 126, 136, respectively, that pass through teeth 112. Belt splice 240 is shown in FIGS. 18-19 with the zigzag outline of first and second fingertips 122, 132 defining first and second lines 126, 136, respectively, that pass through the “V” of notches 108.

### Belt Connection Testing

Two different versions of endless drive belts 100 were fabricated for testing, belt splice 240 and belt connection 140. Both belt splice 240 and belt connection 140 included first and second fingers 121, 131 cut with the same zigzag profile, fused together with the process described above. Belt splice 240 differed from belt connection 140 in the location of the zigzag cuts used to make first and second fingers 121, 131 relative to notches 108 and teeth 112. Long term testing of both belt splice 240 and belt connection 140 revealed that the location of the zigzag cuts used to make first and second fingers 121, 131 can affect the life of endless drive belt 100.

The first endless drive belt 100 tested used belt splice 240 shown in FIGS. 18-19. Belt splice 240 included first and second fingertips 122, 132 aligned with notches 108. With belt splice 240, each of first and second fingertips 122, 132 fell into the bending portions created by notches 108. During testing, the fused urethane material of belt segments 110 surrounding first and second fingertips 122, 132 was subjected to repeated forward bending (FIG. 11) and backward bending (FIG. 12). Positioned at a narrow portion of the “V” shaped notch 108 between rigid teeth 112, fingertip 122b of center finger 121b is subjected to a tight bend and a high stress. This can be the tightest bend and/or highest stress of any point on endless drive belt 100.

After the failure of belt splice 240 at first and second fingertips 122, 132, belt connection 140 of the present embodiment was created to move first and second fingertips 122, 132 away from the bending areas created by notches 108. As shown in FIG. 17, belt connection 140 positioned first and second fingertips 122, 132 away from the bending areas caused by notches 108 and into the oval areas of stiffness 176 caused by teeth 112. In belt connection 140, first fingertips 122 define first line 126 and second fingertips 132 define second line 136, and both first and second lines 126, 136 pass through teeth 112. For belt connection 140, central fingertip 122b is positioned away from the high stress, narrow portion of the “V” shaped notch 108, and located in a non-bending tooth 112. Positioning central fingertip 122b within tooth 112 can eliminate bending of the fused material about fingertip 122b. This can increase the amount of material fused together about fingertip 112b to include both flat belt height 116 plus tooth height 118. This reduced the loads and stresses around fingertip 122b by spreading the loads and stresses across a greater surface area. Fingertips 122, 132 generally fall into the oval areas of stiffness 176, which reduces bending and the stresses thereabout. The durability of belt connection 140 of the present innovation was proven when connection 140 did not fail during long duration testing.

The foregoing description of an embodiment has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. Although only a limited number of embodiments of the invention are explained in detail, it is to be understood that the invention is not limited in its scope to the details of construction and arrangement of components set forth in the preceding description or illustrated in the drawings. The invention is capable of other embodiments and of being practiced or carried out in various ways. Also, specific terminology had been used for the sake of clarity. To the extent that the term “includes” is used in either the detailed description or the claims, such term is intended to be inclusive in a manner similar to the term “comprising” as “comprising” is interpreted when employed as a transitional word in a claim. It is to be understood that each specific term includes all technical equivalents which operate in a similar manner to accomplish a similar purpose. It is intended that the scope of the invention be defined by the claims submitted herewith.

What is claimed is:

1. A joined endless drive belt comprising:
a thermoplastic belt segment having a first end and a second end with alternating stiff portions and bendable portions therebetween;
a first set of fingers with first fingertips terminating the first end of the thermoplastic belt segment;
a second set of fingers with second fingertips terminating the second end of the thermoplastic belt segment, wherein the second set of fingers intermesh with the first set of fingers;
a connection joining the endless drive belt together, the connection joining the intermeshed second set of fingers to the first set of fingers with the first fingertips and the second fingertips located in a stiff portion of the thermoplastic drive belt.

2. The joined endless drive belt of claim 1 wherein a cross section of the conveyor drive belt has a generally flat belt portion having a drive surface and a rib portion extending from the drive surface.

3. The joined endless drive belt of claim 2 wherein the guide rib portion has a plurality of equally spaced notches therein extending from the first end to the second end of the thermoplastic belt segment and the notches define the bendable portions in the thermoplastic belt segment.

4. The joined endless drive belt of claim 3 wherein the equally spaced notches extend into the generally flat belt portion.

5. The joined endless drive belt of claim 3 wherein teeth are defined along the thermoplastic belt segment belt between the equally spaced notches, and the teeth define the stiff portions in the thermoplastic drive belt.

6. The joined endless drive belt of claim 5 wherein at least one finger from the first set of fingers and the second set of fingers includes at least one notch therein.

7. The joined endless drive belt of claim 5 wherein the stiff portions and the bending portions are configured to align when the first set of fingers and second set of fingers are intermeshed.

8. The joined endless drive belt of claim 5 wherein at least one finger on the first end and second end includes at least part of a tooth.

9. The joined endless drive belt of claim 2 wherein at least one of the fingers from the first set of fingers and the second set of fingers includes at least one tooth.

10. The joined endless drive belt of claim 2 wherein the joined endless belt can bend at the notches to bring adjacent teeth into contact with each other.

11. A toothed endless belt comprising:
a thermoplastic belt segment with a plurality of teeth extending from a tooth side of said belt,
a plurality of intermeshable fingers placed in each end of the thermoplastic belt segment with fingertips thereon defining the ends of the belt;
a connection fusing the thermoplastic of the plurality of intermeshed fingers together with each of the fused ends of the belt in-line with a tooth.

12. A toothed endless belt comprising:
a thermoplastic belt segment with a plurality of teeth extending from a tooth side of said belt with notches therebetween;
a plurality of intermeshable fingers placed in each end of the thermoplastic belt segment with fingertips thereon defining the ends of the belt; and
a connection fusing the thermoplastic of the plurality of intermeshed fingers together with each of the fingertips positioned in a low stress area.

13. The toothed endless belt of claim 12 wherein the low stress areas are generally oval shaped.

14. The toothed endless belt of claim 12, wherein the teeth define the low stress area.

15. A toothed endless belt comprising:
a thermoplastic belt segment having a “T” shaped profile comprising a flat belt portion and a guide rib portion extending from the flat belt portion, the guide rib portion having a plurality of notches indented in the guide rib portion to define bending portions in the thermoplastic belt segment and teeth therebetween;
a plurality of intermeshable fingers placed in each end of the thermoplastic belt segment with fingertips thereon defining the ends of the belt; and
a connection fusing the thermoplastic of the plurality of intermeshed fingers together, wherein the connection has the fused ends of the belt positioned away from the bending portions of the belt.

16. A method of joining the ends of a thermoplastic belt together comprising:
providing:
a) a thermoplastic belt segment comprising a first end and a second end with alternating stiff portions and bendable portions therebetween, a first set of fingers with first fingertips terminating the first end of the thermoplastic belt segment, a second set of fingers with second fingertips terminating the second end of the belt, wherein the second set of fingers intermesh together with the first set of fingers with the first and second fingertips located in a stiff portion of the belt, and
b) a connection tool comprising a heater and an alignment frame having a plurality of cavities configured to hold the intermeshed first end and second ends of the thermoplastic belt together;
placing the intermeshed ends of the thermoplastic belt segment into the alignment plate; and
heating the connection tool to melt the intermeshed ends of the thermoplastic belt segment together with the first and second fingertips located in a stiff portion of the belt.

17. The method of claim 16 further comprising cooling the connection tool to fuse the melted intermeshed ends of the thermoplastic belt segment together into a connection with the first and second fingertips located in a stiff portion of the belt.
